(19) United States
(12) Patent Application Publication
(10) Pub. No.: US 2022/0234560 A1
(43) Pub. Date: Jul. 28, 2022

(54) POWER BRAKE-PRESSURE GENERATOR FOR A HYDRAULIC VEHICLE BRAKE SYSTEM

(71) Applicant: Robert Bosch GmbH, Stuttgart (DE)

(72) Inventors: Andreas Weh, Sulzberg (DE); Martin Winkler, Sonthofen (DE); Martin Hagspiel, Rettenberg (DE); Matthias Mayr, Rettenberg (DE); Stefan Kaserer, Ofterschwang (DE)

(21) Appl. No.: 17/612,545

(22) PCT Filed: Apr. 24, 2020
(86) PCT No.: PCT/EP2020/061493

§ 371 Date: Nov. 18, 2021

(30) Foreign Application Priority Data
Jun. 27, 2019 (DE) 10 2019 209 425.2

(51) Int. Cl. B60T 13/14; B60T 17/08; F04B 17/03

(52) U.S. Cl. CPC B60T 13/148; F04B 17/03; B60T 17/08

(57) ABSTRACT

Displacement of a piston of a power brake pressure producer of a hydraulic assembly of a hydraulic vehicle brake system by an electric motor, via a cycloidal gear and a sliding screw gear having a trapezoidal thread.

### FIELD

The present invention relates to a power brake pressure generator for a hydraulic vehicle brake system.

### BACKGROUND INFORMATION

The power brake pressure generator is provided for a brake pressure buildup and/or for the conveying of brake fluid for a slip controlling and/or for a brake pressure buildup for a power braking. Slip control systems are anti-locking, drive slippage, and/or driving dynamics regulating/electronic stability programs, for which the abbreviations ABS, ASR, and/or FDR/ESP are standardly used. Driving dynamics regulation systems/electronic stability programs are also commonly referred to as slip and slide protection. Anti-slip control systems are conventional and are not explained here.

German Patent Application No. DE 10 2017 214 563 A1 describes a hydraulic assembly having a cuboidal hydraulic block that has a cylinder hole into which a cylinder sleeve is pressed in which a piston is accommodated in axially displaceable fashion. The cylinder hole, or the cylinder sleeve and the piston, form a piston-cylinder unit. For a displacement of the piston, the conventional hydraulic assembly has an electric motor that displaces the piston in the cylinder sleeve via a planetary gear as a reduction gear mechanism and a ball screw gear. The ball screw gear is situated in coaxial fashion in the piston, fashioned as a hollow piston. The electric motor is configured, coaxially to the cylinder sleeve, externally on the hydraulic block, and the planetary gear is also configured coaxially to the cylinder sleeve, between the electric motor and the cylinder sleeve or the ball screw gear.

### SUMMARY

A power brake pressure generator according to an example embodiment of the present invention has a piston-cylinder unit, a screw gear, a mechanical reduction gear mechanism, and a drive motor, the drive motor being in particular an electric motor. The reduction gear, which is effectively situated between the drive motor and the screw gear, reduces a rotational drive movement of the drive motor and transmits it to the screw gear. The screw gear converts the rotational drive movement into a translational movement in order to displace a piston in a cylinder of the piston-cylinder unit, and, conversely, the cylinder can also be displaced on the piston. “Effectively” here means that the reduction gear transmits the rotational drive movement of the drive motor, with a lower rotational speed, to the screw gear.

According to an example embodiment of the present invention, the reduction gear is a cycloidal gear. A cycloidal gear has the advantage that it has small dimensions, in particular axially, and that its driveshaft and its output shaft lie along the same axis. In addition, a cycloidal gear is a rolling gear, and is therefore low-wear, and has a large reduction ratio. A large reduction ratio enables a high drive rotational speed, a small drive torque, and thus a small and light drive motor.

Developments and advantageous embodiments of the present invention are disclosed herein.

In accordance with an example embodiment of the present invention, as a screw gear, a sliding screw gear is provided, meaning a screw gear whose threads slide on one another. In comparison with, for example, a ball screw gear, which when axially loaded has a high degree of mechanical tension between its balls and its threads, a sliding screw gear has force-transmitting surfaces that are many times larger, which reduce mechanical tensions to a fraction of what a smaller screw gear enables. Due to the high load-bearing capacity, the sliding screw gear has, in particular, trapezoidal threads.

All the features disclosed in the description herein and in the figures may be realized individually or, in principle, in any combination in specific embodiments of the present invention. Embodiments of the present invention that do not have all, but have only one or some features of a specific embodiment of the present invention are possible.

### BRIEF DESCRIPTION OF THE DRAWINGS

In the following, the present invention is explained in more detail based on a specific embodiment shown in the figures.

FIG. 1 shows a section of a hydraulic assembly having a power brake pressure producer according to the present invention.

FIG. 2 shows individual parts of a cycloidal gear of the power brake pressure producer of FIG. 1, in a perspective exploded view.

### DETAILED DESCRIPTION OF EXAMPLE EMBODIMENTS

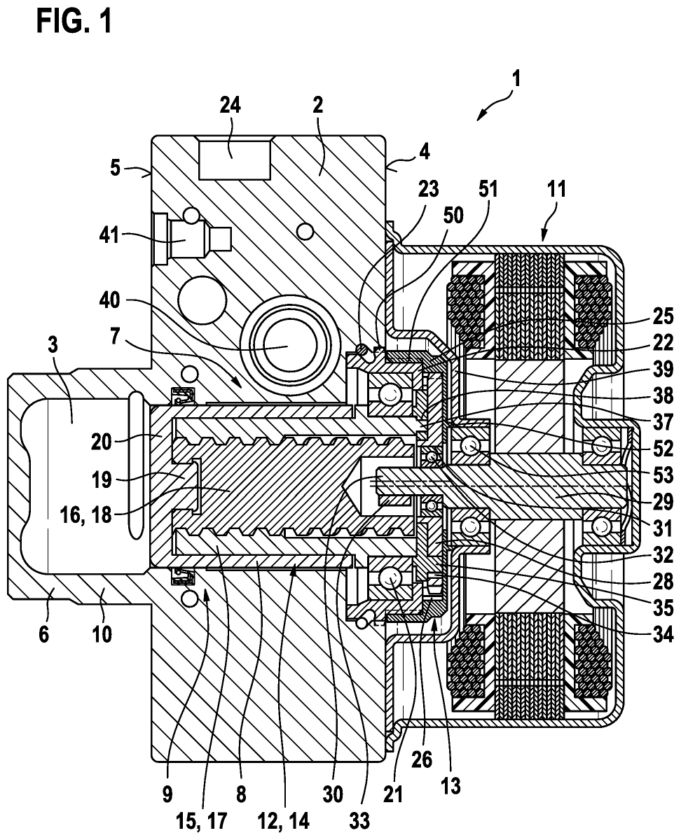

FIG. 1 shows a hydraulic assembly 1 that is provided in order to produce pressure in a hydraulic vehicle power brake system, and/or to produce pressure and to convey brake fluid in a slip-controlled hydraulic vehicle brake system during a slip controlling. Such slip controlling systems are for example anti-lock systems, drive slippage controlling and/or driving dynamics regulation/electronic stability programs, for which the abbreviations ABS, ASR, and/or FDR/ESP are standardly used.

Hydraulic assembly 1 has a hydraulic block 2 that is used for mechanical fastening and hydraulic switching of hydraulic and other components of the slip controlling, such as magnetic valves, check valves, hydrostorage devices, and damping chambers. The components are situated on and in hydraulic block 1, and are hydraulically connected to one another by a boring (not shown) of hydraulic block 2 corresponding to a hydraulic circuit plan of the vehicle power brake system and the slip controlling.

In the depicted and described specific embodiment of the present invention, hydraulic block 2 is a cuboidal flat metal block made of, for example, an aluminum alloy, provided with borings in order to accommodate the components, and bored corresponding to the hydraulic circuit plan of the vehicle brake system and the slip controlling system.

Hydraulic block 2 has a power brake pressure producer 7 that is explained below; hydraulic block 2 can also be regarded as a component of power brake pressure producer 7 according to the present invention.

Hydraulic block 2 has a cylinder hole 3 that is made perpendicular to two large sides, situated opposite one another, of hydraulic block 2 in hydraulic block 2. Cylinder hole 3 is open at one of the two large sides of hydraulic block 2, here referred to as engine side 4. The oppositely situated large side of hydraulic block 2 is here referred to as valve side 5. At this side, hydraulic block 2 has, in the exemplary embodiment, a bowl-shaped prolongation 6 of cylinder hole 3, protruding axially to cylinder hole 3, so that as a result cylinder hole 3 is axially longer than the thickness of hydraulic block 2.

In cylinder hole 3, a piston 8 is accommodated so as to be axially displaceable, which in the exemplary embodiment is a cylindrical tube-shaped hollow piston having an open end and a closed end. Piston 8 and cylinder hole 3 form a piston-cylinder unit 9 that is a component of power brake pressure producer 7 according to the present invention. Cylinder hole 3 forms a cylinder 10 of piston-cylinder unit 9.

For the displacement of piston 8 in cylinder hole 3, power brake pressure producer 7 has an electric motor as drive motor 11, a screw gear 12, and a cycloidal gear 13 as mechanical reduction gear.

The electric motor forming drive motor 11 is configured coaxially to cylinder 10 or to cylinder hole 3, externally at the engine side 4 of hydraulic block 2.

In the depicted and described specific embodiment of the present invention, screw gear 12 is a sliding screw gear 14 having a rotationally drivable spindle nut 15 and an axially displaceable spindle 16 whose threads slide on one another when there is a rotation of spindle nut 15. Screw gear 12 does not have any balls or similar roller elements. Spindle nut 15 can in general also be understood as a rotationally drivable drive element 17, and spindle 16 can be understood as a displaceable output element 18 of screw gear 12. Constructions are also possible in which spindle 16 is rotationally driven and spindle nut 15 is displaced (not shown). In this case, the spindle would form the rotationally drivable drive element, and the spindle nut would form the displaceable output element of the screw drive. Screw gear 12/sliding screw gear 14 has a trapezoidal thread in the exemplary embodiment.

Screw gear 12 is configured coaxially in piston 8, fashioned as a hollow piston, and is also configured coaxially in cylinder hole 3, forming cylinder 10, of hydraulic block 2. Piston 8 fashion as a hollow piston has a head pin 19 on an inner side of a piston floor 20 onto which spindle 16 of screw gear 12 is snapped, which spindle has for this purpose a corresponding blind hole having a circumferential radial groove on its base, into which a head of head pin 19 is snapped.

Piston 8 is displaced axially in cylinder hole 3 of hydraulic block 2, i.e., in cylinder 10 of piston-cylinder unit 9 of power brake pressure producer 7 according to the present invention, by a rotational drive of spindle nut 15, or in general of the rotational drive element 17 of screw gear 12. Through the displacement of piston 8 in cylinder hole 3, or in cylinder 10, a brake pressure is produced for an actuation of hydraulic wheel brakes (not shown) that are connected to wheel connections 24 of hydraulic block 2 via brake lines (not shown). During a slip controlling, brake fluid is conveyed by displacing piston 8 in cylinder hole 3, or in cylinder 10.

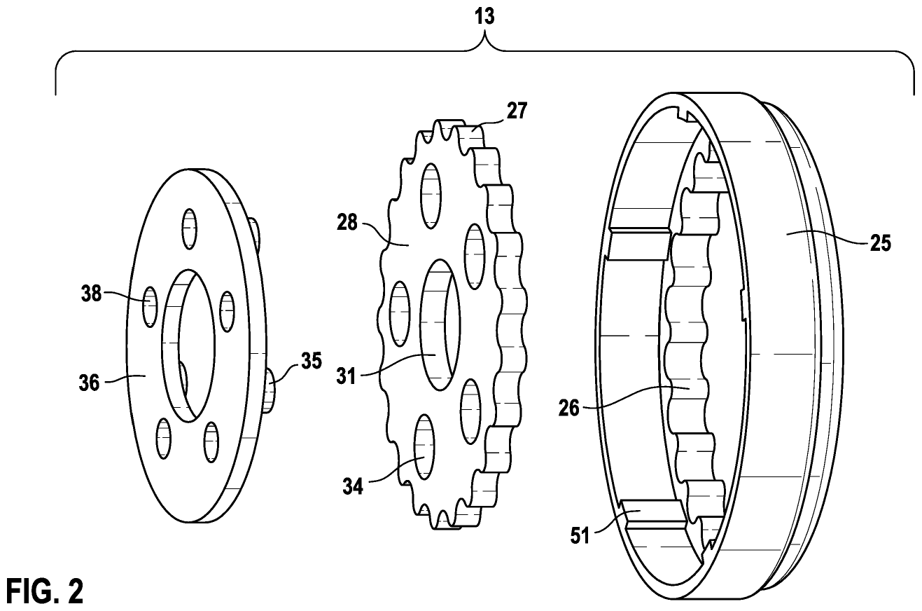

Spindle nut 15 is rotatably mounted outside piston 8 in a ball bearing as rotational bearing 21. Rotational bearing 21 is situated in an annular bearing mount 22 that is pressed into an annular step at the opening of cylinder hole 3 in hydraulic block 2, and is fastened to a spring ring 23 that engages in a circumferential groove externally in bearing mount 22 and in a circumferential groove internally in a circumferential wall of the annular step at the opening of cylinder hole 3. Bearing mount 22 has a parallel knurling 50 having axially parallel grooves (see FIG. 2) that, when pressed into a circumferential wall of the annular step, conforms to the opening of cylinder hole 3 and holds bearing mount 22 on hydraulic block 2 in rotationally fixed fashion.

Cycloidal gear 13, whose individual parts are shown in FIG. 2, forms a mechanical reduction gear that is situated coaxially between the electric motor forming drive motor 11 and screw gear 10. A hollow gear 25 of cycloidal gear 13 is fastened on bearing mount 22 of rotational bearing 21 of spindle nut 15 of screw gear 12, and stands out from the annular step at the opening of cylinder hole 3 in hydraulic block 2.

Hollow gear 25 has an internal toothing 26 having wave-shaped rounded teeth with which an external toothing of a curved plate 28 of cycloidal gear 13 meshes, which has complementarily wave-shaped rounded teeth. Curved plate 28 has a diameter that is smaller by at least the height of a tooth than the internal toothing 26 of hollow gear 25, and curved plate 28 is configured in axially parallel fashion and eccentrically in hollow gear 25 in such a way that its external toothing 27 meshes, at a point on the circumference, with internal toothing 26 of hollow gear 25. In a rotational drive, curved plate 28 runs on a circular path in hollow gear 25, so that the circumferential point at which the toothings 26, 27 mesh runs around in hollow gear 25. Here, curved plate 28 rotates about its axis.

Hollow gear 25 has, internally, axially parallel ribs 51 that engage in axially parallel grooves in the outer circumference of bearing mount 22, whereby hollow gear 25 is situated in rotationally fixed fashion on bearing mount 22. Axially, ribs 51 extend up to an end face of internal toothing 27, and hollow gear 25 is set onto bearing mount 22 until its inner toothing comes to be seated on bearing mount 22. For example, hollow gear 25 is pressed onto bearing mount 22, or is shrink-fitted thereon, or is welded therewith.

A motor shaft 29 of the electric motor forming drive motor 11 has an axially parallel, eccentric pin, made in one piece therewith, as eccentric 30 that extends through a center hole 31 of curved plate 28 of cycloidal gear 13. On eccentric 30 of motor shaft 29 there is situated a ball bearing as rotational bearing 32 on which center hole 31 of curved plate 28 of cycloidal gear 13 is situated. When drive motor 11 is rotationally driven, motor shaft 29 rotates, causing rotary bearing 32 to execute a circular movement on eccentric 30 that moves curved plate 28 on the circular path in hollow gear 25 of cycloidal year 13. Through the engagement of toothings 26, 27 of hollow gear 25 and curved plate 28, curved plate 28 carries out a rotation about its axis, in additional to its circular movement. Instead of a ball bearing, for example a roller bearing or needle bearing, or also a sliding bearing, can be provided as rotational bearing 32, or curved plate 28 is immediately mounted in sliding fashion on eccentric 30 (not shown).

In order to compensate an imbalance of eccentric 30 and rotational bearing 32 situated thereon, motor shaft 29 of the electric motor forming drive motor 11 has a balancing weight 33.

Axially, hollow gear 25 of cycloidal gear 13 is supported on a bearing shield 39 of drive motor 11. Via hollow gear 25, rotational bearing 21 of screw gear 12 is supported axially on bearing shield 39 of the electric motor forming drive motor 11, and via rotational bearing 21 spindle nut 15 of screw gear 12, which forms drive element 17 of screw gear 12, is also supported axially on bearing shield 39 of the electric motor forming drive motor 11. Drive motor 11, or its bearing shield 39, forms a kind of axial counter-support that axially supports cycloidal gear 13 and screw gear 12.

On an end face oriented towards drive motor 11, hollow gear 25 of cycloidal gear 13 has a coaxial collar 52 in the shape of a cylindrical tube that axially overlaps a motor bearing 53 that stands out a short distance axially from bearing shield 39. In this way, drive motor 11 is centered on hollow gear 25 of cycloidal gear 13.

In order to communicate its rotation to screw gear 12, curved plate 28 of cycloidal gear 13 has circular through-holes 34 that are situated around its center hole 31 and are distributed around a circumference. Drive pins 35 of a perforated plate that forms a output element 36 of cycloidal gear 13 engage in through-holes 34. Due to the eccentricity of curved plate 28, drive pins 35 have a smaller diameter than do the through-holes 34 in which they engage.

For a rotationally fixed connection of output element 36 of cycloidal gear 13 with spindle nut 15, which forms drive element 17 of screw gear 12, pins 37 stand out from an end face of spindle nut 15 oriented towards cycloidal gear 13, which pins engage in holes 38 that are made between drive pins 35 in output element 36 of cycloidal gear 13.

In the depicted and described specific embodiment of the present invention, hydraulic block 2 has a master brake cylinder bore 40 in which a master brake cylinder piston (not shown) can be situated that is mechanically displaceable in master brake cylinder bore 41 via a piston rod, by a foot brake pedal (not shown) or a hand brake lever.

In valve side 5 of hydraulic block 2, diametrally stepped blind holes are made as receptacles 41 for magnetic valves (not shown). The magnetic valves are components of the slip controlling and of a brake pressure controlling that provide a regulation or controlling of the brake pressure or of wheel brake pressures in the wheel brakes. Equipped with the components of the slip controlling system, hydraulic block 2 forms hydraulic assembly 1.

1-6. (canceled)

7. A power brake pressure producer for a hydraulic vehicle brake system, comprising:
a piston-cylinder unit;
a drive motor;
a screw gear that converts a rotational drive movement of the drive motor into a translational movement to displace a piston in a cylinder of the piston-cylinder unit, and
a mechanical reduction gear that is effectively situated between the drive motor and the screw gear and that reduces the drive movement of the drive motor and transmits it to the screw gear;
wherein the reduction gear is a cycloidal gear.

8. The power brake pressure producer as recited in claim 7, wherein: (i) an output element of the cycloidal gear is rotationally fixed with a rotatable drive element of the screw gear, and/or (ii) a hollow gear of the cycloidal gear in which a curved plate of the cycloidal gear rolls in eccentrically rotational fashion, is radially fixed and axially fixed with a rotational bearing of the rotatable drive element of the screw gear.

9. The power brake pressure producer as recited in claim 7, wherein the screw gear is a sliding screw gear.

10. The power brake pressure producer as recited in claim 7, wherein the drive motor has an eccentric that drives the cycloidal gear and has a balancing weight for compensating an imbalance of the eccentric.

11. A hydraulic block for a hydraulic assembly of a hydraulic vehicle brake system, including a power brake pressure producer having a piston-cylinder unit, a drive motor, a screw gear that converts a rotational drive movement of the drive motor into a translational movement to displace a piston in a cylinder of the piston-cylinder unit, and a mechanical reduction gear that is effectively situated between the drive motor and the screw gear and that reduces the drive movement of the drive motor and transmits it to the screw gear, wherein the reduction gear is a cycloidal gear, wherein: (i) an output element of the cycloidal gear is rotationally fixed with a rotatable drive element of the screw gear, and/or (ii) a hollow gear of the cycloidal gear in which a curved plate of the cycloidal gear rolls in eccentrically rotational fashion, is radially fixed and axially fixed with a rotational bearing of the rotatable drive element of the screw gear, and wherein the rotational bearing of the rotatable drive element of the screw gear is fastened on the hydraulic block.

12. The hydraulic block as recited in claim 11, wherein the hydraulic block has the cylinder of the piston-cylinder unit, and the drive motor is situated on the hydraulic block, and supports the cycloidal gear axially in a manner of a counter-bearing.
